(19) United States
(12) Patent Application Publication
(10) Pub. No.: US 2007/0071887 A1
(43) Pub. Date: Mar. 29, 2007

(54) Methods of inhibiting corrosion of a metal surface

(75) Inventors: Juanita M. Cassidy, Duncan, OK (US); Chad E. Kiser, Comanche, OK (US); Jim L. Lane, Duncan, OK (US); Keith A. Frost, Duncan, OK (US)

Correspondence Address: Halliburton Energy Services, Inc., 2600 S. 2nd Street, Duncan, OK, 73536-0440, US

(73) Assignee: Halliburton Energy Services, Inc.

(21) Appl. No.: 11/235,397

(22) Filed: Sep. 26, 2005

(51) Int. Cl. B05D 5/12; B05D 3/02; B05D 7/22; B05D 1/36

(52) U.S. Cl. 427/97.7; 427/372.2; 427/230; 427/419.2

(57) ABSTRACT

Among the methods provided is a method comprising: providing a corrosion inhibitor composition, the corrosion inhibitor composition comprising a group 15 metal source and a cinnamaldehyde compound: contacting the metal surface with the corrosion inhibitor composition: and allowing the corrosion inhibitor composition to interact with the metal surface so as to inhibit corrosion of the metal surface.

### CROSS-REFERENCE TO RELATED APPLICATIONS

The present invention is related to co-pending U.S. application Ser. No. ______ [Attorney Docket No. HES 2005-IP-016983U2] entitled “Corrosion Inhibitor Compositions and Associated Methods,” filed concurrently herewith, the entire disclosure of which is incorporated herein by reference.

### BACKGROUND

The present invention relates to corrosion inhibitor compositions for inhibiting the corrosion of metals and more particularly, to corrosion inhibitor compositions useful for inhibiting metal corrosion in acidic environments and associated methods.

Acidic treatment fluids may be used for a multitude of operations in the oil and chemical industry. Metal surfaces exposed to acidic treatment fluids include piping and tubing used in industrial chemical equipment such as, for example, in heat exchangers and reactors. Acidic treatment fluids are also often used as a treating fluid in wells penetrating subterranean formations. Such acidic treatment fluids may include, for example, acidic clean-up fluids or stimulation fluids for oil and gas wells. Acidic stimulation fluids may include, for example, fluids used in hydraulic fracturing and matrix acidizing treatments. As used herein, the term “treatment fluid” refers to any fluid that may be used in a subterranean application in conjunction with a desired function and/or for a desired purpose. The term “treatment fluid” does not imply any particular action by the fluid or any component thereof.

Acidic treatment fluids may include a variety of acids such as, for example, hydrochloric acid, formic acid, hydrofluoric acid, and the like. While acidic treatment fluids may be useful for a variety of downhole operations, acidic treatment fluids can be problematic in that they can cause corrosion to downhole production tubing and downhole tools.

To combat this potential corrosion problem, an assortment of corrosion inhibitors have been used to reduce or prevent corrosion to downhole metals and metal alloys with varying levels of success. A difficulty encountered with the use of some corrosion inhibitors is the limited temperature range over which they may function effectively. For instance, certain conventional antimony-based inhibitor formulations have been limited to temperatures above 270° F., because they do not appear to function effectively below this temperature.

Another drawback of some conventional corrosion inhibitors is that certain corrosion inhibitors components may not be compatible with the higher environmental standards of some regions. One illustrative example relates to use quaternary ammonium compounds or “Mannich” condensation compounds. These compounds are generally not acceptable under stricter environmental regulations, such as those applicable in the North Sea region or other regions. Consequently, operators in some regions may be forced to suffer increased corrosion problems, to resort to using less desirable corrosion inhibitor formulations that may be less effective, or to forego the use of certain acidic treatment fluids entirely.

### SUMMARY

The present invention relates to corrosion inhibitor compositions for inhibiting the corrosion of metals and more particularly, to corrosion inhibitor compositions useful for inhibiting metal corrosion in acidic environments and associated methods.

An example of a method of inhibiting corrosion of a metal surface comprises providing a corrosion inhibitor composition, the corrosion inhibitor composition comprising a group 15 metal source, a cinnamaldehyde compound, and an acetylenic compound; contacting the metal surface with the corrosion inhibitor composition; and allowing the corrosion inhibitor composition to interact with the metal surface so as to inhibit corrosion of the metal surface.

Another example of a method of inhibiting corrosion of a metal surface comprises providing a corrosion inhibitor composition, the corrosion inhibitor composition comprising a group 15 metal source and a cinnamaldehyde compound; contacting the metal surface with the corrosion inhibitor composition; and allowing the corrosion inhibitor composition to interact with the metal surface so as to inhibit corrosion of the metal surface.

Corrosion inhibitor compositions of the present invention may further comprise one or more of the following components: an additional aldehyde compound, an acetylenic compound, a surfactant, an iodide source, and a solvent.

The features and advantages of the present invention will be apparent to those skilled in the art. While numerous changes may be made by those skilled in the art, such changes are within the spirit of the invention.

### DESCRIPTION OF PREFERRED EMBODIMENTS

The present invention relates to corrosion inhibitor compositions for inhibiting the corrosion of metals and more particularly, to corrosion inhibitor compositions useful for inhibiting metal corrosion in acidic environments and associated methods.

In certain embodiments, the corrosion inhibitor compositions may comprise a group 15 metal source, a cinnamaldehyde compound, an additional aldehyde compound, an acetylenic compound, a surfactant, an iodide source, and a solvent. Not all of these components are essential elements of the inhibitor corrosion composition. One or more of these components may be omitted in specific embodiments. As will be more clear throughout this disclosure and the claims, some of the components are optional in certain embodiments. One of the advantages of the inhibitor corrosion compositions of the present invention is that they may be more effective than corrosion inhibitors heretofore used and/or may possess desirable environmental properties for use in downhole environments, especially those that may be subject to more stringent environmental regulations. Another advantageous feature of the present invention is that the corrosion inhibitors of the present invention do not require the presence of quaternary ammonium compounds or “Mannich” condensation compounds to function.

Environments in which corrosion inhibitor compositions of the present invention may be particularly effective include any downhole application in which the environment is relatively acidic. Such acidity may pose a problem for any metal surfaces present therein. In some embodiments, the corrosion inhibitor compositions of the present invention may be used as an additive in an acidic treatment fluid that is placed downhole. Examples of acidic treatment fluids include, but are not limited to, acidic well treatment fluids that may comprise hydrochloric acid, acetic acid, formic acid, hydrofluoric acid, glycolic acid, and mixtures thereof. In certain embodiments, the corrosion inhibitor compositions of the present invention may be used in subterranean environments that have a bottom hole temperature ranging from about 70° F. to about 500° F.

The metal surfaces to be protected by the corrosion inhibitor compositions of the present invention include any metal surface susceptible to corrosion in an acidic environment including, but not limited to, ferrous metals, low alloy metals (e.g., N-80 Grade), stainless steel (e.g., 13 Cr), copper alloys, brass, nickel alloys, and duplex stainless steel alloys. Such metal surfaces include downhole piping, downhole tools, and the like.

Corrosion inhibitor compositions of the present invention may comprise a group 15 metal source. The term, “group 15 metal source,” as used herein refers to those metal compounds of group 15 of the periodic table, namely compounds of arsenic, antimony, bismuth and derivatives thereof. The term, “group 15,” as used herein, refers to the IUPAC naming convention of the periodic table. Derivatives of group 15 metals may include any compound that may act as a source of a group 15 metal in an oxidized state such as, for example, salts of the group 15 metals. Group 15 compounds suitable for use in the present invention include, but are not limited to, antimony trioxide; antimony tetraoxide; and antimony pentoxide; antimony halide compounds such as antimony trichloride, antimony pentachloride, antimony trifluoride, and antimony pentafluoride; antimony tartrate; antimony citrate; alkali metal salts of antimony tartrate and antimony citrate; potassium pyroantimonate and other alkali metal salts thereof; antimony adducts of ethylene glycol; other similar antimony compounds; and mixtures thereof. Examples of bismuth compounds that can be employed include, but are not limited to, bismuth oxide compounds such as bismuth trioxide, bismuth tetraoxide, and bismuth pentaoxide; bismuth halides such as bismuth trichloride, bismuth tribromide, and bismuth triiodide; bismuth tartrate; bismuth citrate; alkali metal salts of bismuth tartrate and bismuth citrate; bismuth oxyhalogens; other similar bismuth compounds; and mixtures thereof.

The group 15 metal source may be present from about 0.002% to about 2% by weight of acid solution. In certain exemplary embodiments, the weight percent of the group 15 metal source may be present from about 0.01% to about 0.6% by weight of acid solution.

Corrosion inhibitor compositions of the present invention may comprise a cinnamaldehyde compound. The cinnamaldehyde compound of the present invention refers to cinnamaldehyde and cinnamaldehyde derivatives. Cinnamaldehyde derivatives may include any compound that may act as a source of cinnamaldehyde in mixtures encountered during use of the corrosion inhibitors of the present invention. Examples of cinnamaldehyde derivatives suitable for use in the present invention include, but are not limited to, dicinnamaldehyde, p-hydroxycinnamaldehyde, p-methylcinnamaldehyde, p-ethylcinnamaldehyde, p-methoxycinnamaldehyde, p-dimethylaminocinnamaldehyde, p-diethylaminocinnamaldehyde, p-nitrocinnamaldehyde, o-nitrocinnamaldehyde, o-allyloxycinnamaldehyde, 4-(3-propenal)cinnamaldehyde, p-sodium sulfocinnamaldehyde, p-trimethylammoniumcinnamaldehyde sulfate, p-trimethylammoniumcinnamaldehyde, o-methylsulfate, p-thiocyanocinnamaldehyde, p-(S-acetyl)thiocinnamaldehyde, p-(S-N,N-dimethylcarbamoylthio)cinnamaldehyde, p-chlorocinnamaldehyde, α-methylcinnamaldehyde, β-methylcinnamaldehyde, α-chlorocinnamaldehyde, α-bromocinnamaldehyde, α-butylcinnamaldehyde, α-amylcinnamaldehyde, α-hexylcinnamaldehyde, α-bromo-p-cyanocinnamaldehyde, α-ethyl-p-methylcinnamaldehyde, p-methyl-α-pentylcinnamaldehyde, cinnamaloxime, cinnamonitrile, 5-phenyl-2,4-pentadienal, 7-phenyl-2,4,6-heptatrienal, and mixtures thereof.

The cinnamaldehyde compound may be present from about 0.005% to about 5% by weight of acid solution. In certain exemplary embodiments, the weight percent of the cinnamaldehyde compound may be present from about 0.02% to about 1% by weight of acid solution.

In certain embodiments, corrosion inhibitor compositions of the present invention may optionally comprise an additional aldehyde compound. The additional aldehyde compound may be used in combination with the cinnamaldehyde compound to enhance the corrosion inhibition of the corrosion inhibitor compositions. Examples of suitable additional aldehyde compounds include, but are not limited to, formaldehyde, formaldehyde sources, benzaldehyde, crotonaldehyde, furfuraldehyde, paraformaldehyde, paraldehyde, glyoxal, glyoxalic acid, hexamethylenetetramine, and mixtures thereof. The additional aldehyde compound may be present from about 0.001% to about 5% by weight of acid solution. In certain exemplary embodiments, the weight percent of the additional aldehyde compound may be present from about 0.004% to about 1% by weight of acid solution.

In certain embodiments, the corrosion inhibitor compositions of the present invention may comprise an acetylenic compound. The presence of an acetylenic compound is not necessary or essential in all embodiments of the present invention. Certain embodiments of the present invention may not include an acetylenic compound. Acetylenic compounds are thought to act as an active plating promoter so as to enhance the plating of the corrosion inhibitor composition on the surface of the metal being inhibited. Acetylenic compounds of the present invention may include acetylenic alcohols such as, for example, acetylenic compounds having the general formula: R₁CCCR₂R₃OH where R₁, R₂, and R₃ are hydrogen, alkyl, phenyl, substituted phenyl, or hydroxy-alkyl radicals. Preferably, R₁ comprises hydrogen. Preferably, R₂ comprises hydrogen, methyl, ethyl, or propyl radicals. Preferably, R₃ comprises an alkyl radical having the general formula CₙH₂ₙ, where n is an integer from 1 to 10. The acetylenic compound R₁CCCR₂R₃OR₄ may also be used where R₄ is a hydroxy-alkyl radical. Examples of acetylenic alcohols suitable for use in the present invention include, but are not limited to, methyl butynol, methyl pentynol, hexynol, ethyl octynol, propargyl alcohol, benzylbutynol, ethynylcyclohexanol, ethoxy acetylenics, propoxy acetylenics, and mixtures thereof. Preferred alcohols are hexynol, propargyl alcohol, methyl butynol, ethyl octynol, propargyl alcohol ethoxylate (for example, Golpanol PME), propargyl alcohol propoxylate (for example, Golpanol PAP), and mixtures thereof. When used, the acetylenic compounds may be present in an amount from about 0.01% to about 10% by weight of acid solution. In certain embodiments, the addition of an acetylenic compound may be indicated at temperatures above 250° F. In certain exemplary embodiments, an acetylenic compound may be present in an amount from about 0.1% to about 1.5% by weight of acid solution.

In certain embodiments, the corrosion inhibitor compositions of the present invention may comprise a surfactant. The presence of a surfactant is not essential or required in all embodiments of the present invention. A surfactant may aid in the dispersibility of the corrosion inhibitor composition and/or may assist in the plating of the corrosion inhibitor composition on the metal surfaces to be inhibited. In certain embodiments, a surfactant may aid in achieving a more uniform plating on the metal surface. Preferably, the surfactant is cationic or nonionic (i.e., not anionic). The presence of a surfactant may be especially advantageous at temperatures above about 250° F. Examples of surfactants suitable for use in the present invention include, but are not limited to, dimethyldicocoalkylamine oxide, lauryl alcohol ethoxylate, cocoalkylamine ethoxylate, and mixtures thereof. When used, a surfactant may be present in an amount from about 0.05% to about 10% by weight of acid solution. In certain embodiments, the addition of a surfactant may be indicated at temperatures above 250° F. In certain exemplary embodiments, a surfactant may be present from about 0.1% to about 1% by weight of acid solution.

Certain embodiments of the corrosion inhibitor compositions of the present invention may optionally comprise an iodide source. The iodide source may be iodine or any compound that releases iodide in the environments in which the corrosion inhibitor composition is used. Iodide sources suitable for use in the present invention include, but are not limited to, the antimony, bismuth, potassium, sodium, calcium, magnesium, cesium, and zinc salts of iodine.

When used, the iodide source may be present in an amount sufficient to promote proper adhesion of the organic corrosion inhibitor compounds or group 15 metal to the alloy surface. The iodide source may be present in an amount from about 0.001% to about 3% by weight of acid solution. In certain exemplary embodiments, an iodide source may be present from about 0.01% to about 1.5% by weight of acid solution.

Certain embodiments of the corrosion inhibitor compositions of the present invention may optionally comprise a solvent. The solvent may be any glycol or glycol ether. Glycols and glycol ethers suitable for use in the present invention include, but are not limited to, ethylene glycol, propylene glycol, diethylene glycol, polyethylene glycol, or propylene glycol propyl ether. A solvent may aid in achieving, among other things, a more uniform inhibitor plating on a metal surface in certain embodiments. Other solvents that may be used to solubilize the inhibitor composition include alcohols, such as, for example, methanol, isopropanol, 2-ethyl-1-hexanol, butanol, etc.

When used, the solvent may be present in an amount sufficient to promote a more uniform metal inhibitor plating. The solvent may be present in an amount from about 0.05% to about 5% by weight of acid solution. In certain exemplary embodiments, a solvent may be present from about 0.5% to about 1% by weight of acid solution.

Generally, the methods of the present invention allow for inhibiting a portion of a metal surface in a well bore. The corrosion inhibitor compositions of the present invention may be used as a stand-alone treatment fluid or may be used as an additive in another treatment fluid. In one embodiment, a method of treating a portion of a subterranean formation comprises: providing a corrosion inhibiting composition comprising a group 15 metal source; a cinnamaldehyde compound; providing an acidic treatment fluid; contacting the metal with the acidic treatment fluid and the corrosion inhibiting composition; and allowing the corrosion inhibiting composition to inhibit corrosion of the metal. Certain embodiments of the corrosion inhibitor compositions may further comprise one or more of the following components: an additional aldehyde compound, an acetylenic compound, a surfactant, an iodide source, and a solvent. In certain embodiments, the corrosion inhibitor compositions of the present invention may be substantially free of quaternary ammonium compounds and Mannich condensation compounds.

To facilitate a better understanding of the present invention, the following examples of certain aspects of some embodiments are given. In no way should the following examples be read to limit, or define, the scope of the invention.

### EXAMPLES

### Example 1

Table 1 shows the results of corrosion tests performed at ambient pressure on N-80 steel using a variety of corrosion inhibitor compositions. The corrosion loss data were generated using the weight loss method. Coupon specimens were cleaned and weighed prior to their immersion in 100 mL of a 15% HCl acid blend. The coupon specimens (˜4.4 in²) were placed into glass containers and heated in a 200° F. constant temperature water bath containing the indicated corrosion inhibitor formulation for four hours at ambient pressure. The following amounts of each component were used in all tests: 20 lb/Mgal KI, 1.4 mL cinnamaldehyde, 1 ml Golpanol PME, 0.5 ml Aromox DMC, 1 mL propylene glycol propyl ether, 0.4 g Bi₂O₃ predissolved in 2 mL 31.45% HCl. Following the test, the coupons were weighed again to determine the amount of corrosion loss by comparing the final weight of the specimen to its initial weight before the test. The presence of plating was then determined by visual inspection after cleaning and polishing the specimens. Table 1 shows that treatments using formulations 4-10 reduced the corrosion rate as compared to formulations 1, 2, and 3.

TABLE 1
Ambient Pressure Corrosion Tests

| | | Corrosion Loss | Visible Bi |
|---|---|---|---|
| Formulation | Composition | (lb/ft²) | Plate |
| 1 | Bi₂O₃ | 0.306 | No |
| 2 | KI, Bi₂O₃ | 0.175 | No |
| 3 | KI, cinnamaldehyde, Bi₂O₃ | 0.057 | No |
| 4 | KI, cinnamaldehyde, HMTA^{†}, Bi₂O₃ | 0.003 | Yes |
| 5 | KI, cinnamaldehyde, DMC^{‡}, Bi₂O₃ | 0.004 | Yes |
| 6 | KI, cinnamaldehyde, HMTA, DMC, Bi₂O₃ | 0.004 | Yes |
| 7 | Cinnamaldehyde, Golpanol PME^{††}, Bi₂O₃ | 0.005 | Yes |
| 8 | KI, cinnamaldehyde, Golpanol PME, Bi₂O₃ | 0.005 | Yes |
| 9 | KI, cinnamaldehyde, Golpanol PME, DMC, | 0.005 | Yes |
| | Bi₂O₃ | | |
| 10 | KI, cinnamaldehyde, Golpanol PME, DMC, | 0.001 | Yes |
| | propylene glycol propyl ether, Bi₂O₃ | | |

^{†}HMTA—hexamethylenetetramine
^{‡}Aromox DMC - a dimethyldicocoalkylamine oxide surfactant, commercially available from Akzo Nobel
^{††}Golpanol PME - a 2-hydroxyethyl propargyl ether, commercially available from BASF, also known as propargyl alcohol ethoxylate

Table 2 shows results of pressurized corrosion tests performed on N-80 steel. For these test, a mixture of 1.2 wt % NaI, 34.5 wt % cinnamaldehyde, 3 wt % HMTA, and 48.8 wt % propylene glycol, and 12.5 wt % DMC were pre-blended before being added to a 15% HCl solution. Bi₂O₃ was predissolved in 31.45% HCl to provide the bismuth, and was administered at 0.4075 g Bi₂O₃ per 100 mL acid blend for the formulations indicating Bi as the group 15 metal used, and a 2 vol % of a solution of potassium pyroantimonate in ethylene glycol was used to provide the antimony for the formulations indicating “Sb” as the group 15 metal used. The tests were preformed in Hastelloy autoclaves at a pressure of 1000 psi at the temperatures indicated in Table 2 for a duration of three hours (with the exception of formulation 5, which was at atmospheric pressure for the duration of the test).

Table 2 shows that corrosion inhibitor formulations 2-7 with bismuth or antimony reduced the corrosion rate as compared to the same corrosion inhibitor formulation used without a bismuth or antimony source.

TABLE 2
Pressurized Corrosion Tests

| | | | Corrosion | |
|---|---|---|---|---|
| | Group 15 | Temperature | Loss | |
| Formulation | Metal Used | (° F.) | (lb/ft²) | Visible Plate |
| 1 | — | 275 | 0.185 | — |
| 2 | Bi | 275 | 0.001 | Yes |
| 3 | Bi | 325 | 0.002 | Yes |
| 4 | Bi | 375 | 0.015 | Yes |
| 5 | Bi | 400 | 0.020 | Yes |
| 6 | Sb | 200* | 0.017 | Yes |
| 7 | Sb | 375 | 0.011 | Yes |

*atmospheric pressure

Table 3 shows the results of several pressurized corrosion tests performed on N-80 steel immersed in a corrosion inhibitor formulation using certain surfactants. For these tests, a mixture 20 lb/Mgal KI, 1.45 vol % cinnamaldehyde, 50 lb/Mgal HMTA, and 34 lb/Mgal Bi₂O₃ was mixed with 0.5 vol % of the indicated surfactant in a 15% HCl solution. The tests were run for three hours at a pressure of 1000 psi at 275° F. Table 3 shows the efficacy of certain nonionic and cationic surfactants (formulations 2 and 3 respectively) as compared to an anionic surfactant (formulation 1).

TABLE 3
Pressurized Corrosion Tests Using Certain Surfactants

| Formulation | Surfactant | Corrosion Loss (lb/ft²) |
|---|---|---|
| 1 | Ammonium dodecylsulfate (an | 0.050 |
| | anionic surfactant) | |
| 2 | Lauryl alcohol ethoxylate (23 mol) | 0.015 |
| | (a nonionic surfactant) | |
| 3 | Aromox DMC (a cationic | 0.003 |
| | surfactant) | |

Table 4 shows the results of a pressurized corrosion test performed on N-80 steel using the following corrosion inhibitor formulation by weight: 1.2% NaI, 30% cinnamaldehyde, 10% SCA-130 (an aldehyde commercially available from Halliburton Energy Services, Inc.), 7.5% DMC, 1% Golpanol PME, 2% lauryl alcohol ethoxylate (23 mol), 19.7% diethyleneglycol, and 19.7% hexylene glycol. This formulation was preblended before addition to a 15% HCl solution. Bismuth oxide (0.4 g) was predissolved in 31.45% HCl and added separately to formulation 2 whereas formulation 1 had no bismuth source. The test was run for three hours at a pressure of 1000 psi. The reduced corrosion shown in formulation 2 of Table 4 demonstrates the efficacy of this formulation as compared to the same formulation used with no bismuth metal source.

TABLE 4
Pressurized Corrosion Test

| | | Temperature | Corrosion Loss | Visible |
|---|---|---|---|---|
| Formulation | Group 15 Metal | (° F.) | (lb/ft²) | Plate |
| 1 | — | 300 | 0.291 | — |
| 2 | Bi | 300 | 0.001 | Yes |

Table 5 shows results of a pressurized corrosion test performed on N-80 steel using the following corrosion inhibitor formulation by weight: 1.2% NaI, 30% cinnamaldehyde, 7.5% DMC, 10% Golpanol PME, 2% lauryl alcohol ethoxylate (23 mol), 24.7% diethyleneglycol, and 24.7% hexylene glycol. This formulation was preblended before addition to a 15% HCl solution. Bismuth oxide (0.4 g) was predissolved in 31.45% HCl and added separately to formulation 2. The test was run for three hours at a pressure of 1000 psi. The reduced corrosion of formulation 2 shown in Table 5 demonstrates the efficacy of this formulation as compared to the same formulation used with no bismuth metal source.

TABLE 5
Pressurized Corrosion Test

| | | Temperature | Corrosion Loss | Visible |
|---|---|---|---|---|
| Formulation | Group 15 Metal | (° F.) | (lb/ft²) | Plate |
| 1 | — | 300 | 0.308 | — |
| 2 | Bi | 300 | 0.005 | Yes |

Therefore, the present invention is well adapted to attain the ends and advantages mentioned as well as those that are inherent therein. While numerous changes may be made by those skilled in the art, such changes are encompassed within the spirit of this invention as defined by the appended claims. The terms in the claims have their plain, ordinary meaning unless otherwise explicitly and clearly defined by the patentee.

1. A method of inhibiting corrosion of a metal surface comprising:
providing a corrosion inhibitor composition, the corrosion inhibitor composition comprising a group 15 metal source, a cinnamaldehyde compound, and an acetylenic compound;
contacting the metal surface with the corrosion inhibitor composition; and
allowing the corrosion inhibitor composition to interact with the metal surface so as to inhibit corrosion of the metal surface.

2. The method of claim 1 wherein the group 15 metal source is a compound of antimony, a salt of antimony, a compound of bismuth, or a salt of bismuth.

3. The method of claim 1 wherein the group 15 metal source is chosen from the group consisting of: antimony trioxide; antimony tetraoxide; antimony pentoxide; an antimony halide compound; antimony trichloride; antimony pentachloride; antimony trifluoride, antimony pentafluoride; antimony tartrate; antimony citrate; an alkali metal salt of antimony tartrate; antimony citrate; potassium pyroantimonate; an antimony adduct of ethylene glycol; a bismuth oxide compound; bismuth trioxide; bismuth tetraoxide; bismuth pentaoxide; a bismuth halide; bismuth trichloride; bismuth tribromide; bismuth triiodide; bismuth tartrate; bismuth citrate; an alkali metal salt of bismuth tartrate, an alkali metal salt of bismuth citrate; a bismuth oxyhalogen; and mixtures thereof.

4. The method of claim 1 wherein the cinnamaldehyde compound is chosen from the group consisting of: dicinnamaldehyde, p-hydroxycinnamaldehyde, p-methylcinnamaldehyde, p-ethylcinnamaldehyde, p-methoxycinnamaldehyde, p-dimethylaminocinnamaldehyde, p-diethylaminocinnamaldehyde, p-nitrocinnamaldehyde, o-nitrocinnamaldehyde, o-allyloxycinnamaldehyde, 4-(3-propenal)cinnamaldehyde, p-sodium sulfocinnamaldehyde, p-trimethylammoniumcinnamaldehyde sulfate, p-trimethylammoniumcinnamaldehyde, o-methylsulfate, p-thiocyanocinnamaldehyde, p-(S-acetyl)thiocinnamaldehyde, p-(S-N,N-dimethylcarbamoylthio)cinnamaldehyde, p-chlorocinnamaldehyde, α-methylcinnamaldehyde, β-methylcinnamaldehyde, α-chlorocinnamaldehyde, α-bromocinnamaldehyde, α-butylcinnamaldehyde, α-amylcinnamaldehyde, α-hexylcinnamaldehyde, α-bromo-p-cyanocinnamaldehyde, α-ethyl-p-methylcinnamaldehyde, p-methyl-α-pentylcinnamaldehyde, cinnamaloxime, cinnamonitrile, 5-phenyl-2,4-pentadienal, 7-phenyl-2,4,6-heptatrienal, and mixtures thereof.

5. The method of claim 1 wherein the acetylenic compound is propargyl alcohol, propoxylated propargyl alcohol, 2-hydroxyethyl propargyl ether, or a mixture thereof.

6. The method of claim 1 wherein the corrosion inhibitor composition further comprising an iodide source.

7. The method of claim 6 wherein the iodide source is an antimony, bismuth, potassium, sodium, calcium, magnesium, cesium, or zinc salt of iodine or a mixture thereof.

8. The method of claim 1 further comprising an additional aldehyde compound.

9. The method of claim 8 wherein the additional aldehyde compound is formaldehyde, formaldehyde sources, crotonaldehyde, furfuraldehyde, paraformaldehyde, paraldehyde, or a mixture thereof.

10. The method of claim 8 wherein the additional aldehyde compound is benzaldehyde, glyoxal, glyoxalic acid, hexamethylenetetramine, or a mixture thereof.

11. The method of claim 1 further comprising a surfactant.

12. The method of claim 11 wherein the surfactant is dimethyldicocoalkylamine oxide, lauryl alcohol ethoxylate, cocoalkylamine ethoxylate, or a mixture thereof.

13. The method of claim 1 further comprising a solvent wherein the solvent is a glycol, a glycol ether, ethylene glycol, propylene glycol, diethylene glycol, polyethylene glycol, propylene glycol propyl ether, or a mixture thereof.

14. A method of inhibiting corrosion of a metal surface comprising:
providing a corrosion inhibitor composition, the corrosion inhibitor composition comprising a group 15 metal source and a cinnamaldehyde compound;
contacting the metal surface with the corrosion inhibitor composition; and
allowing the corrosion inhibitor composition to interact with the metal surface so as to inhibit corrosion of the metal surface.

15. The method of claim 14 wherein the corrosion inhibitor composition further comprises an additional aldehyde compound.

16. The method of claim 14 further comprising an iodide source.

17. The method of claim 14 wherein the corrosion inhibitor composition further comprises a surfactant.

18. The method of claim 15 wherein the corrosion inhibitor composition further comprises an iodide source; a surfactant; and a solvent wherein the solvent is a glycol, a glycol ether, or a combination thereof.

19. The method of claim 14 wherein the corrosion inhibitor composition is substantially free of a quaternary ammonium compound and wherein the corrosion inhibitor composition is substantially free of a Mannich condensation compound.

20. The method of claim 19 used to inhibit the corrosion of a downhole metal surface further comprising the step of introducing the corrosion inhibitor composition downhole in a well bore.
